(19) United States
(12) Patent Application Publication
(10) Pub. No.: US 2019/0009701 A1
(43) Pub. Date: Jan. 10, 2019

(54) AUTOMOTIVE CARPET WITH SOLID MULTILOBAL FIBRE

(71) Applicant: Beaulieu International Group NV, Waregem (BE)

(72) Inventors: Anneleen De Smet, Kruishoutem (BE); Gillis Beun, Izegem (BE)

(73) Assignee: Beaulieu International Group NV, Waregem (BE)

(21) Appl. No.: 16/066,456

(22) PCT Filed: Dec. 23, 2016
(86) PCT No.: PCT/EP2016/082661

§ 371 Date: Jun. 27, 2018

(30) Foreign Application Priority Data
Dec. 30, 2015 (BE) 2015/5853

(51) Int. Cl. B60N 3/04; D04H 1/48; D04H 11/08; D06N 7/00

(52) U.S. Cl. CPC B60N 3/042; B60N 3/048; D01D 5/253; D04H 11/08; D06N 7/0068; D04H 1/48

(57) ABSTRACT

An automotive carpet is described having a needlefelt structure which can be low in weight but having good abrasion resistance. In accordance with embodiments of the present invention the automotive carpet comprises at least a needle punched facing layer as top layer made of staple fibers, wherein the staple fibers comprise at least 50% by weight of solid multilobal fibers, and at least a partial binding. A process for making this automotive carpet is described comprising the steps of: conveying a fibrous card web to a crosslapping machine and crosslapping the card web into a batt of material, wherein the multilobal nonwoven crosslapper travelling distance is less than 20% and larger than 10% bigger than the final width of the needle punched facing layer.

### BACKGROUND

Automotive carpeting is a separate class of carpets which can be used for aesthetic reasons but also for noise attenuation, or increasing comfort of driving environments and the carpet can be used on the floor as carpet or mats, for interior side trims, in the trunk or boot of a vehicle or even on the inner side of the roof Such carpets conventionally use a surface or pile layer, a primary backing layer, a back coating, and a substrate. The primary backing layer may be made from a nonwoven material.

The fibres used in such carpet can be polyamide, polyester or polyolefin such as polypropylene. They can be BCF (Bulked Continuous Filament), e.g. comprising a number of single filaments. A common BCF that is used for automotive carpet is polyamide (PA) but also polyethylene terephthalate (PET) and polypropylene (PP) fibres can be used.

Automotive carpet should be abrasion resistant, resistant to stress whitening, be easily cleanable, aesthetically pleasing, allow recycling etc. Abrasion and stress whitening can be measured by a Taber test machine. Cost reduction is an overriding requirement of such carpet.

Typically, a round cross-section fibre based nonwoven is used whereby the pile portion can be needle punched non-woven fabric forming the surface layer. A primary backing cloth under the above pile portion can be applied. A latex can be used to impregnate the back surface of the carpet.

Thus for automotive applications it would be best to provide an economical, lightweight carpet rather than a conventional carpet. One potential way to lighten the carpet would be to omit parts the carpet such as laminated materials or latexes. However, to omit such structural materials is accompanied with a reduction in various important properties of carpets such as the strength and stiffness.

A needlefelt is a staple fibre based needlepunched nonwoven which is subsequently bound by using a latex compound, a binder fibre or a binder powder. Commonly, round cross-section staple fibres are used automotive carpet of this type. Automotive carpets using round cross-section fibres usually have a weight range above 400 g/m².

Needle punched non-woven face layers can be produced using an industrial scale needle punch carpet production line. For example, staple fibers are mixed and formed into a bat or mat using carding and cross-lapping. The mat can be pre-needled using plain barbed needles to form a carpet face layer. The needled mat can be coated with latex and optionally a backing. A backing can include a felt backing layer.

Automotive carpet is a separate class of carpet because the use is different. Carpet on side trims has a much lower loading than conventional domestic carpet although there can be abrasion. Carpet on the floor is usually not subject to the continuous passage of persons but is subject to scuffing by shoes and boots and by being soaked with water from shoes and boots in times of rain or snow. For comparative purposes it is conventional for automotive carpets, to make reference and comparative samples that can be tested for abrasion using the Taber test according to DIN 53109 or the equivalent SAE J1530. The reference samples are usually made with round cross-section staple fibres.

With respect to cost, round cross-section staple fibres are customarily used in automotive carpet and are readily available at a reasonable price.

Contrary to the situation with round cross-section staple fibres, there are technical and commercial objections relating to the spinning and use of multilobal fibres such as trilobal fibres for carpeting:

Specialised equipment such as an adapted spinplate is needed to spin the fibre. Lower fibre output compared to conventional round fibre.

There is usually more running waste.

Also more pigment can be needed to reach the same color depth compared to round fibre of the same dtex.

Other weight saving geometries like hollow fibres are also more difficult to spin.

### SUMMARY OF THE INVENTION

The present invention provides an automotive carpet having a needlefelt structure and a method of making the same. An advantage of e an automotive carpet according to embodiments of the present invention is a reduction weight and/or cost, while keeping or improving performance as required for an automotive. For example, an advantage of e an automotive carpet according to embodiments of the present invention is a low weight but a good coverage and abrasion resistance.

In accordance with embodiments of the present invention an automotive carpet is provided comprising:
at least a needle punched facing layer as top layer made of staple fibers, wherein the staple fibers comprise at least 50% by weight of solid multilobal fibers, and at least a partial binding of the fibres of the needle punched facing layer.

In the an automotive carpet the solid multilobal fiber content of the facing layer can be at least 60%, at least 70%, at least 80% or at least 90% by weight of the total fiber content in the needle punched facing layer, preferably up to 100% by weight.

The fibers of the facing layer are at least partially bound, e.g. by latex, bonding fiber or bonding powder. The binding does not need to be a separate layer. It can be a backing layer. A backing layer can be less preferred if it has a significant impact on the overall manufacturing cost whereby instead of a separate backing layer, the needlefelt can be bound by a latex compound, a heat activated binder fibre or a heat activated binder powder, for example. Hence the backing can be a separate binding layer or can be integrated into the non-woven fibre structure as a binding.

The outer cross-section of the multilobal solid fibers can be substantially trilobal or quadrilobal (form of a cross) etc.

Carpets according to embodiments of the present invention have good coverage while having a low weight. In known nonwovens, good coverage can be provided by a dense fibre packing as this has as much polymer material as possible to block transmitted light in any cross-section of the carpet. Such a compact fibre density would provide good coverage but would inevitably increase weight.

In accordance with embodiments of the present invention the lobed nature of the fibre creates “lobe tip-to-adjacent fibre” and “lobe tip-to-lobe tip” touching which spaces the fibres from each other. This form of packing allows a low weight with a high coverage in which air replaces polymer. The tips of the lobes preferably have convex surfaces. The cross-sectional shape of the fibres can include concave surfaces between adjacent lobe tips. These concave portions will allow a weight saving by substituting air for polymer material. In a nonwoven and in an automotive carpet according to embodiments the present invention, a porosity percentages of greater than 75%, preferably 90-95% of air can be achieved. This is beneficial because it allows the carpet to soak up and trap water by capillary action while still allowing the water to evaporate with time.

The facing layer can be printed, e.g. preferably digitally printed so that the automotive carpet can be customized to a requirement rather than stocking large quantities of pre-customised carpet. In accordance with embodiments of the present invention carpet can be stocked in a selection of standard colours, such as red, blue, green etc. and the final customized printing relates to specific deigns or patterns applied onto the standard coloured carpet.

A needlefelt as used in embodiments of the present invention is a staple fibre based needle punched nonwoven which is subsequently at least partially bound by using a latex compound, a binder fibre or a binder powder. The carpet can be provided with a separate backing layer but this can be less preferred.

Embodiments of the present invention use staple fibres with a multilobal such as trilobal cross-section with a modification ratio up to 6, preferably 2 to 4.

In a preferred embodiment the weight of the non-woven needlefelt top or facing layer (base weight) is between 100 and 300 grams per square meter, for example more preferred between 150-275 grams per square meter. Fibre linear mass densities are preferably between 3.3 until 17 dtex, whereby there can be a mixture of linear mass densities of the fibre within one carpet. For example flat and structured automotive carpet can be made with a fibre of 8.9 dtex, white flat and structured automotive carpet can have a mixture of 3.3, 6.7 and 8.9 dtex. Fibres up to 17 dtex can be used for automotive carpet with velour qualities, e.g. from 7 to 17 or from 9 to 17 dtex, which can be used as an interior side trim for example.

A technical advantage of carpets in accordance with embodiments of the present invention can be the mass homogeneity of nonwoven facing layer with solid multilobal such as solid trilobal fibres.

Also the coverage (ability to prevent see-through) is better for a multilobal such as trilobal carpet compared weight-for-weight.

Another advantage is that a higher modulus can be achieved compared to round fibres when using multilobal such as trilobal fibre when used with the same stitch density, needling efficiency effect. A higher fibre-fibre friction can also be achieved.

Another technical advantage is a higher dimensional stability throughout the binding or backing process, leading to a final product that is consistently better in terms of dimensional stability such as less wrinkles and skewing.

Also the web is more closed, has a more even surface, and has a better weight homogeneity.

An advantage of embodiments of the present invention can be a higher coverage to weight ratio for multilobal fibres such as trilobal fibres compared to round staple fibres, resulting in a weight saving of saving of at least 10%, preferably greater than 15% such as up to 25% or 30% compared to round fibers of the same dtex or round fibres of the same coverage (but therefore different dtex).

An advantage of embodiments of the present invention can be a higher needling efficiency, for example meaning higher web modulus at equal needling parameters compared to a round cross-section based needlefelt of the same base weight.

An advantage of embodiments of the present invention can be better crosslapper behaviour, e.g. a lower crosslapping width needed for a certain end width of the carpet.

An advantage of embodiments of the present invention can be lower absorption of precoat backing material leading to lower overall carpet weight, e.g. for flat automotive carpet with the same needling settings as the current round fibre carpet. This effect can lead to significant lower weight of the end product.

An advantage of embodiments of the present invention can be a lower end weight for other backing methods.

An advantage of embodiments of the present invention can be a higher homogeneity of carpet meaning lower weight variation in machine and cross machine direction.

An advantage of embodiments of the present invention can be a lower carbon footprint compared to current versions.

The multilobal fibre of the automotive carpet preferably has a lobed cross-sectional geometry including a discrete number of lobes each having a tip, and a solid central core section running axially through the fibre, each outer side of the fibre defining a curved contour extending between each tip and a neighbouring tip.

Each side of the multilobal fibre can include a concave region located at an approximate midpoint between neighbouring tips. The concave regions enhance weight savings. However triangular and even convex curves in the fibre cross-section can be useful for certain applications.

The multilobal fibre of the automotive carpet preferably has a lobed cross-sectional geometry including a discrete number of lobes each having a tip, and a solid central core section running axially through the fibre, each outer side of the fibre defining a contour extending between each tip and a neighbouring tip, each such contour comprising any one of: a straight line, a concave shape or a convex shape.

In the case of the convex shape the convex shape does not extend out from the core such as to extend beyond a line drawn between two adjacent tips.

The core of the fibre preferably does not include an axial hole or void.

Another aspect of the present invention is a process for making an automotive carpet having at least a needle punched facing layer as top layer made of staple fibers, wherein the staple fibers comprise at least 50% by weight of solid multilobal fibers, the process comprising:

conveying a fibrous card web to a crosslapping machine and crosslapping the card web into a batt of material, wherein the multilobal nonwoven crosslapper travelling distance is less than 20% and larger than 10% bigger than the final width of the needle punched facing layer.

Further a binding may be applied such as a latex, a binding power or a binding fibre.

Further embodiments of the invention are defined in the dependent claims.

### BRIEF DESCRIPTION OF THE DRAWINGS

FIG. 1 is a graph showing light transmission values for various embodiments of the present invention (T190, T210, T225, T240) and comparison value (R300).

FIG. 2 is a graph showing a final precoat backed automotive carpet weight for an embodiment of the present invention (T210) and comparison value (R300).

FIG. 3 is a graph showing weight saving with embodiments of the present invention.

FIG. 4 is a graph showing a precoat backed carpet modulus for an embodiment of the present invention (T210) and comparison value (R300).

FIG. 5 is a graph showing a full bath carpet modulus for an embodiment of the present invention (T210) and comparison value (R300).

FIG. 6 is a table showing thicknesses and thickness variations for various embodiments of the present invention (T210, T260) and comparison value (R300).

FIG. 7a shows various dimensions relevant to multilobal fibre especially trilobal fibre as used in embodiments of the present invention. FIG. 7b shows a possible cross-sectional shape of a trilobal fibre that can be used in embodiments of the present invention. FIG. 7c shows a cut through a non-woven made with trilobal fibres in accordance with an embodiment of the present invention indicating variations in shape of the trilobal fibres.

FIG. 8a shows a bunch of cut trilobal fibres showing crossections of trilobal fibres that can be used in embodiments of the present invention.

FIG. 8b shows a cross-section through a non-woven made with trilobal fibres according to an embodiment of the present invention.

FIG. 8c shows a top view of the non-woven of FIG. 8b.

FIG. 9 shows a schematic cross-section of an automotive carpet according to an embodiment of the present invention.

### DEFINITIONS

The terms “fibre” and “filament” refer to filamentous material that can be used in yarn fabric and non-woven textile fabrication. One or more fibers can be used to produce a yarn. The yarn can be fully drawn or textured according to methods known to the skilled person.

The term “yarn” refers to a continuous strand or bundle of fibers. Yarn can be made of bulked continuous filaments (BCFs). Methods for making BCF yarns for carpets typically include the steps of twisting, heat-setting, tufting, dyeing and finishing.

The term “hollow fibre” relates to a fibre having an inside void space of a tubular structure. A hollow fiber can be spun using a die creating a central lumen in the fiber. The term “solid fibre” relates to a fibre having no inside void space of a tubular structure. Thus a slice through a solid fibre shows no tubular structure or lumen within the fibre. There is therefore no axial hole or void in the fibre nor is there a hole or void inside any of the lobes of a multilobal fibre.

The term “staple” means yarn or strands of short and definite length, such as substantially between 20-120 mm, or between 50-80 mm.

“Bulk” is the property of the fibre or yarn that relates to the surface coverage ability of such a fibre or yarn.

A “non-woven” which can be used with the present invention may be a staple non-woven made by providing cut fibres of a few centimetres length, putting these into bales, placing on a conveyor belt and dispersed, e.g. spread in a uniform web by a wetlaid, airlaid, or carding/crosslapping process.

The preferred fibres for use with the present invention are polypropylene (PP) or polyester (PET) fibres. Non-wovens can be made by a wetlaid process into mats, gauzes, scrims etc. PET or polypropylene fibres can be treated by corona or plasma treatment to improve printing and/or adhesive properties.

The fibres of nonwovens can be bonded either thermally or by using resin. Bonding can be provided throughout the web by resin saturation or for example, overall thermal bonding can be used. Alternatively, bonding can be provided in a distinct pattern via resin printing or thermal spot bonding.

Spunlaid nonwovens are made in one continuous process by spinning and then directly dispersing the fibres into a web by deflectors or can be directed with air streams. Spunboned non-wovens can be combined with meltblown nonwovens.

Any non-woven can be bonded such as by any or combinations of:
thermal bonding
use of a heat sealer
calendered through heated rollers (called spunbond when combined with spunlaid webs)
hydro-entanglement: mechanical intertwining of fibres by water jets called spunlace
ultrasonic pattern bonding
needle punching or needlefelting (preferred method): mechanical intertwining of fibres by needles
chemical bonding (process): use of binders (such as latex emulsion or solution polymers) to chemically join the fibres or use of powders or different fibres that soften and melt to hold other non-melting fibres together.

Non-woven sheets are usually not a very uniform fabric. There can be differences between the machine direction, (MD) and the cross machine direction (CD). These differences show up as differences in tensile strength, elongation, tear strength, and fibre orientation. In accordance with embodiments of the present invention non-wovens can be made with better uniformity.

A “needle felt” as used in embodiments of the present invention is a staple fibre based needlepunched nonwoven which is subsequently provided with a backing such as being bound by using a latex compound, a binder fibre or a binder powder or bounded by a extrusion layer.

The term “needlepunched” means a nonwoven which is consolidated by passing it though one or more needleboards carrying several thousands of needles that penetrate the nonwovens repeatedly, forming a mechanically entangled structure.

The term “carpet” refers to a textile structure including a non-woven face layer and a binding such as a latex or binding powder or binding fibres within the textile structure or a backing such as a backing layer. A carpet can include a primary backing and on the underside of the primary backing one or more layers of material (e.g. a coating layer, an adhesive layer, a secondary backing, or similar) can be applied. These extra layers may hide stitches, improve acoustic properties, increase stiffness of the carpet, increase strength of the carpet. Woven carpets are not relevant to the present invention. The term “carpet” can include a tufted carpet.

The term “automotive carpet” preferably refers to needled floor coverings for automotive applications and can have any of the following in embodiments of the present invention:
a) one visible layer (homogeneous product);
b) more than one visible layer, the binding compound of which does not reach the top of the upper wear surface;
c) more than one visible layer, the binding compound of which is present throughout its thickness.

“Tip diameter,” (Dₜ) as used herein, refers to the distance from one side of a lobe to the other at the tip of a lobe. The term “diameter” does not mean that the tip necessarily has a circular outer contour however it is preferred if the tips are convex.

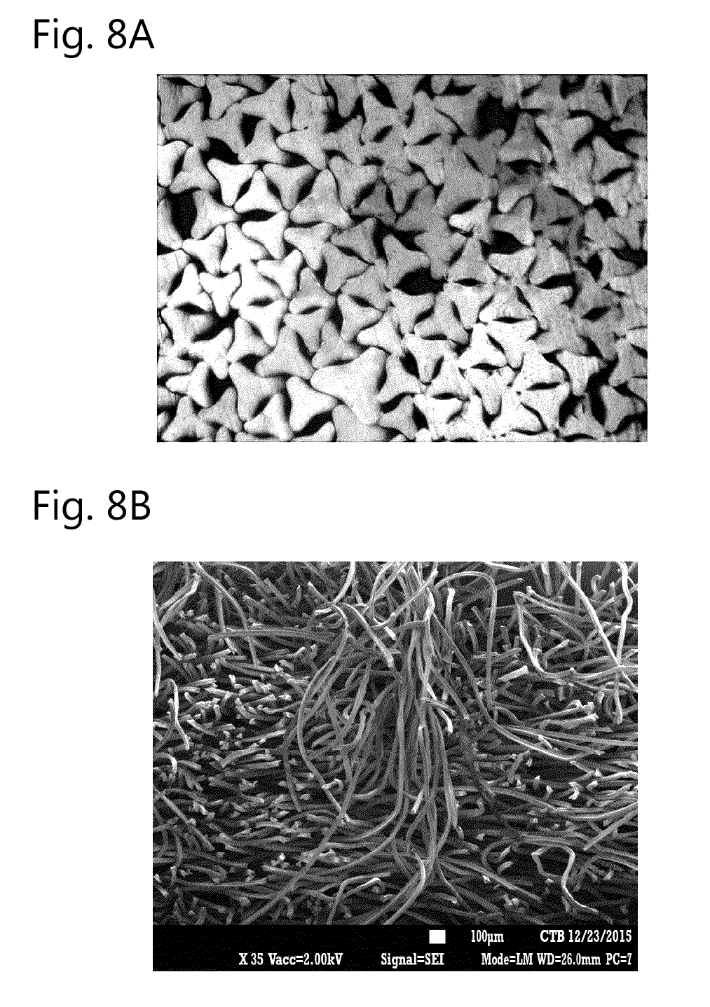

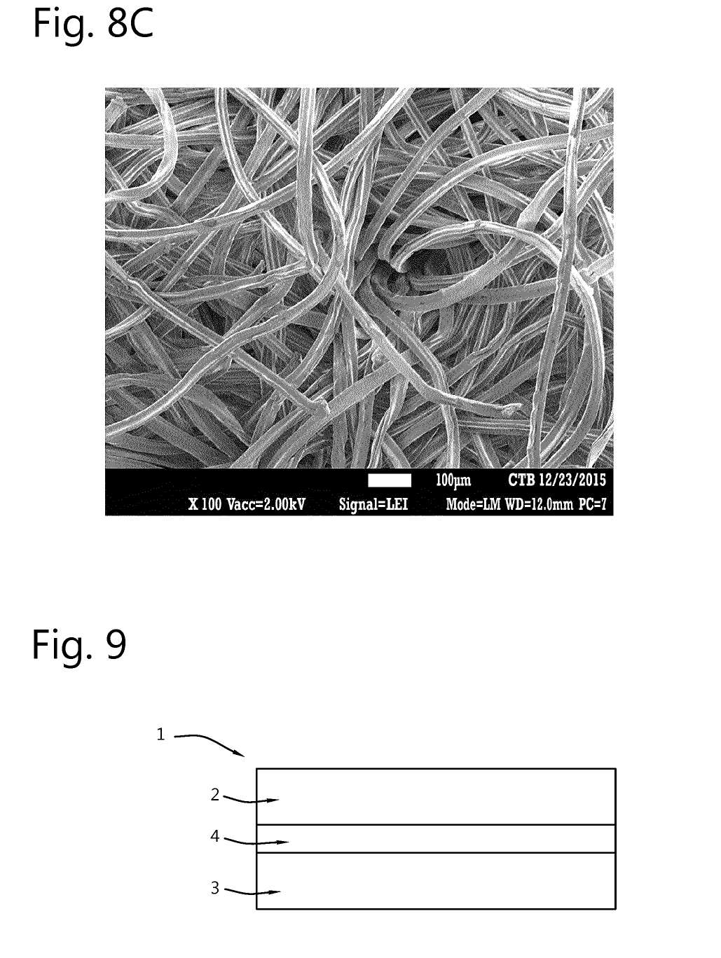

The “modification ratio” is defined as the ratio of the circumscribed circle (having radius Rₒ) around the cross-section of a fibre to the inscribed circle (having the ratio (R_{c}) in the cross-section. This definition means round sections have a minimal value of 1. Profiled fibres have modification ratios exceeding 1. Embodiments of the present invention use staple fibres with a multilobal such as trilobal cross-section with a modification ratio of at least 1.5 and preferably greater than 1.9 or greater than 2 with a maximum of 6 or 4. It is assumed that there can be a practical limit to the modification ratio used for these fibres, because when the lobes of the fibre section become too long the processing might be decreased, or the section might get damaged during stretching, crimping or packaging or other operations. Due to the variation in the shape and size of fibres caused by manufacturing tolerances, the modification is expressed as an average. As can be derived from FIG. 8a the average modification ratio (MR) is, for example, 2.15, measured on trilobal fibre with 5.5 dtex, and is sensibly constant over the range 4.4 dtex to 6.7 dtex.

The term “trilobal” refers to a fibre cross-section which comprises of three lobes and displays a modification ratio greater than 1, e.g. greater than 1.5 and preferably greater than 1.9 or greater than 2 with a maximum of 6 or 4 for embodiments of the invention. The term “Multilobal” refers to a fibre cross-section which comprises of a plurality of lobes and displays a modification ratio greater than 1, e.g. above 1.5 and preferably greater than 1.9 or greater than 2 with a maximum of 6 or 4 for embodiments of the invention.

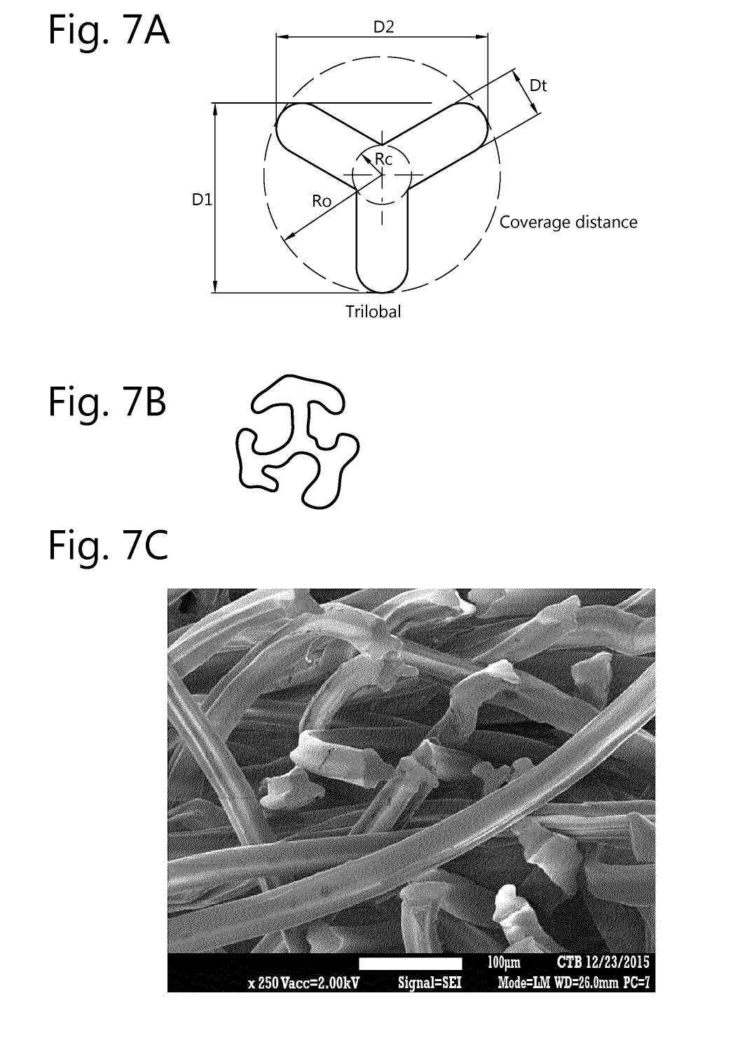

A trilobal fibre has a trilobal cross-sectional geometry including three lobes defined by three tips, and a generally solid central core section running axially through the fibre. A multilobal fibre has a lobed cross-sectional geometry including a discrete number of lobes more than three and hence defined by more than three tips, and also a generally solid central core section running axially through the fibre. Each outer side of the fibre preferably defines a smoothly curved contour extending between each tip and a neighbouring tip, each side preferably including a concave region located at an approximate midpoint between neighbouring tips (see FIG. 7c or FIG. 8a). This enhances weight savings. However triangular and even convex curves can be useful for certain applications. Hence, other shapes are included within the scope of the present invention, however in any shape it is preferred if there is a number of discrete lobes (such as three or four lobes). Preferably, each outer side of the fibre preferably defines a contour extending between each tip and a neighbouring tip, each such contour can comprise any one of the following: a straight line, a concave shape or a convex shape. In the case of the convex shape the convex shape preferably does not extend out from the core such as to extend beyond a line drawn between two adjacent tips.

The core of the fibre does not include an axial hole or void, i.e. the core is solid material. The multifaceted shape of multilobal fibre can provide carpet with a high lustre and good coverage.

Referring to FIG. 7a, each fibre has an outer radius Rₒ extending from a geometric center of the fibre to the circumscribing outer circle and a core radius R_{c} extending from the geometric center of the fibre to the approximate midpoint of the concave region. In embodiments of the present invention, the ratio of the outer radius Rₒ to the core radius R_{c} defines a modification ratio of greater than 1.55, preferably greater than 1.9 such as 2 or up to 4 or 6. Each tip of a lobe has a tip diameter (Dₜ), and in embodiments of the present invention the ratio of the outer radius (Rₒ) to the tip diameter (Dₜ) defines a ratio of, for example, 2.0 to about 10.0. The lobe length is the same as (Rₒ) and has been measured for trilobal fibre with an average modification ratio of 2.15 to be:
lobe length from center was 21 micrometer for 5.5 dtex
lobe length from center was 17.5 micrometer for 4.4 dtex

With reference to the word “binding” different levels of binding can be described:
Chemical binding, e.g. cross-linking of molecules
Physical binding: melting of materials creating a ‘microscopic’ mechanical binding, molecules are mechanically interlocked
Mechanical binding: ‘macroscopic’ mechanical binding in which fibres are mechanically interlocked, not at a molecular level.

Binding fibres or a polyolefin dispersion refer to physical bonding, materials which melt together. Polyethylene can be used to realize such bonding since melting temperature of polyethylene is below melting temperature of polypropylene. The polyethylene fibres or polyethylene dispersion melts and flows in between the other fibers. Consequence of this type of binding, is that two different materials are necessary to bond. Some fibers are not allowed to melt since these need to give the mechanical properties which are lost if the material is molten.

It is preferred in embodiments of the present invention if different materials are not used to realize the bonding. Instead the shape of the multilobal fibres results in a larger contact surface between fibres, in particular with multilobal fibres there are contact areas rather than point or line contact. For this reason preferred embodiments of the present invention can be mono-component fibres as a bi-component function is not essential for the mechanical characteristics achieved by embodiments of the present invention. Hence embodiments of the present invention include non-wovens with no bi-component fibres but just mono-component fibres.

The term “coverage” and “covering distance” refers to the diameter across a fibre of solid material as shown in FIG. 7a. This distance relates to the extent which light is blocked by the solid matter of the fibre and hence relates to the ability of non-woven carpet to hide whatever is underneath the carpet. The coverage distance has been measured for trilobal fibre to be 37.5 micrometer for 5.5 dtex, and 31 micrometer for 4.4 dtex.

Test Methods with Tolerances

The following test methods can be used.

Dimensions: CEN/TS 14159

Total thickness mm: ISO 1765 whereby the tolerance is nominally ±15%

Total mass per unit area g/m² : ISO 8543 whereby the tolerance is nominally the mass ±15%

Calculation of Stiffness

Determine the force (F) on samples with a width of 200 mm that was necessary for 0.5% and 1.5% of strain (ε).

$$Stiffness [ \frac{N}{\%} ] = \frac{( {F}_{1.5 \%} - {F}_{0.5 \%} )}{Δ ɛ}$$

Force in N
Difference in strain Δ_{ε}=1%

Correction for Weight of the Non-Woven

The stiffness shows a linear relation with the weight of a non-woven.

It is preferred to compare samples with similar weights.

The stiffness is corrected for weight by determining a normalized stiffness given by the following normalized to 300 g/m²:

Normalized Stiffness=stiffness ×300 gram per square meter divided by the weight of the measured sample in gram per square meter.

The formula for stiffness itself is given above.

Description of Illustrative Embodiments

The present invention provides an automotive carpet having a needlefelt structure which can be low in weight but having good abrasion resistance and good coverage. This lightweight carpeting is suitable for any of the applications in automotive vehicles. It is made from non-woven polypropylene or polyester fibres. The carpet is also able to meet short term logistic demands such as next working day delivery.

FIG. 9 shows a schematic cross-section of an automotive carpet 1 comprising at least a facing layer 2 which is a needle punched layer. The needle punch automotive carpet according to embodiments of the present invention can comprise only the needle punch facing layer 2 bonded by a binding material. The automotive carpet can include an optional backing layer 3. Embodiments of the present invention include a combination of the needle punched facing layer 2 according to embodiments of the present invention with at least a partial binding such as provided by an impregnation with a latex, or with binding power or using binding fibres which can be activated to bind fibres in the facing layer 2 by heat. Alternatively one or more backing layers 3 can be applied such as a porous backing layer or a single backing layer. The backing 3 may comprise one or more layers such as for instance a latex layer, thermoplastic film layer, a thermoplastic extrusion layer, a foam layer or felt layer such as a needle felt layer. For example an adhesive layer 4 can be used to bind the needle punch facing layer 2 to other layers. A combination of these layers can be assembled, e.g. by needle punching, by lamination, or adhering layer together. Such a multilayer backing can be formed to improve coverage or to enhance acoustic properties which is advantageous in automotive use.

In accordance with embodiments of the present invention an automotive carpet comprises:
at least a needle punched facing layer as top layer made of staple fibers, wherein the staple fibers comprise at least 50% by weight of solid multilobal fibers, and at least a partial binding of fibres in the facing layer.

The outer cross-section of the multilobal solid fibers can be trilobal or quadrilobal or substantially trilobal or quadrilobal (form of a cross) etc. The trilobal fibres can be polypropylene fibres or polyester (PET) fibres.

In the automotive carpet the solid multilobal fiber content of the facing layer can be at least 60%, 70, 80 or 90% by weight of the total fibre content, preferably up to 100% by weight of the total fibre content of the facing layer.

The threshold for improvement in properties of the carpet compared to carpet with round fibres is expected to be at least more than 50% by weight of the overall fibers used for the needle punched facing layer according to the present invention being solid multilobal fibres such as qudrilobal or trilobal fibres.

A needle felt as used in embodiments of the present invention is a staple fibre based needlepunched nonwoven which is subsequently provided with a binding or with a backing such as being bound by using a latex compound, a binder fibre, a binder powder or a binder layer.

Embodiments of the present invention use staple fibres with a multilobal such as trilobal cross-section with a modification ratio of at least 1.5, preferably greater than 1.9, e.g. 2 to 3, and preferably less than 6, e.g. less than 4. The trilobal fibres can be polypropylene fibres or polyester (PET) fibres.

In a preferred embodiments the weight of the non-woven needlefelt top or facing layer (base weight) is between 100 and 300 grams per square meter, for example between 150-275 grams per square meter. Fibre linear mass density is preferably between 3.3 until 17 dtex, whereby there can be a mixture of fibres with different linear mass densities. For example flat and structured automotive carpet can be made with a fibre of 8.9 dtex, white flat and structured automotive carpet can have a mixture of 3.3, 6.7 and 8.9 dtex. Fibres up to 17 dtex can be used for automotive carpet with velour qualities.

The carpet in accordance with embodiments of the present invention can be taken back and re-used in numerous applications, such as car parts, garden chairs and garbage bags.

Commonly, round cross-section staple fibres are used in automotive carpet. Embodiments of the present invention relate to non-wovens made with multilobal, e.g. trilobal cross section staple fibres with a modification ratio of at least 1.5 such as 1.5 to 6, preferably 1.9 or greater, for example, 2 to 4.

The use of multilobal such as trilobal fibres having a modification ratio above 1.5 permits a significant weight reduction over round cross-section fibre based nonwovens used in automotive carpet production, lowering the fibre cost, and reducing the environmental footprint per square meter of this product drastically.

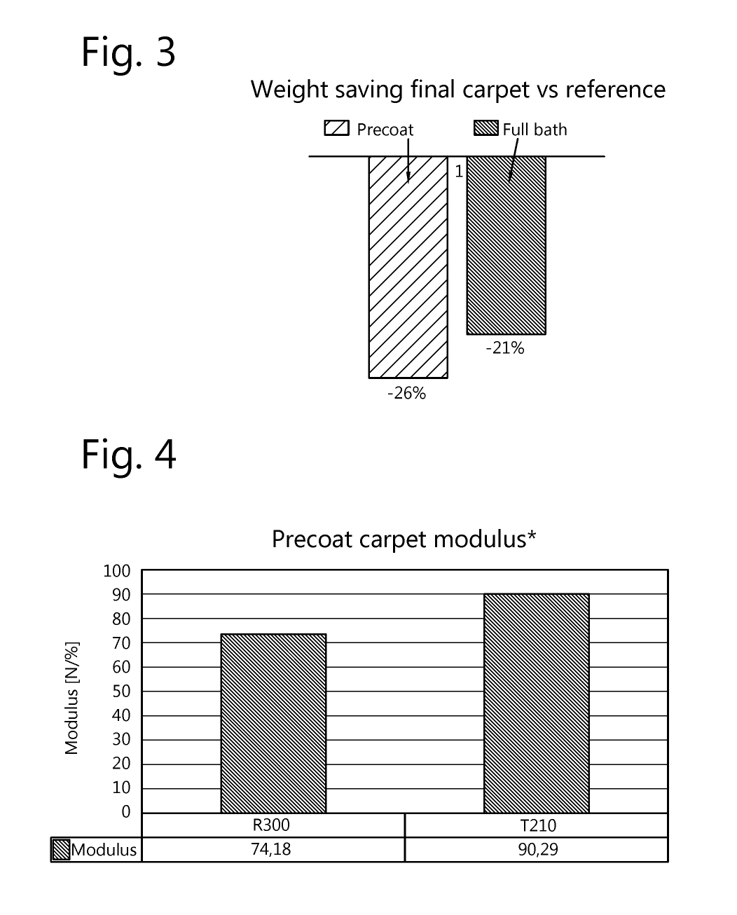

The use of multilobal such as trilobal cross-section fibre instead of round cross-section fibres makes a weight saving on nonwoven level of at least 10%, preferably 15% or more such as up to 25% or 30% compared to round fibers of the same dtex or round fibres of the same coverage (but therefore different dtex). For example, a nonwoven was produced with 5.5 dtex trilobal fibres resulting in a weight of 180 g/m² whereas a nonwoven made with 5.5 dtex round cross-section had a weight of 205 g/m² resulting in a weight saving of 14%. FIG. 3 shows a weight saving of up to 26% on the final carpet. A lower carpet weight in the supply chain reduces cost per square meter of automotive carpet further.

Embodiments of the present invention relate to a combination of a specific multilobal fibre (in dtex, cut length, cross-section) such as having a trilobal fibre cross-section with the use of a nonwoven (specific weight range, needling parameters, buildup, . . . ) needlefelt structure based on this fibre, which is used in the production of automotive carpet with a specific minimal modulus. The trilobal fibres can be polypropylene fibres or polyester (PET) fibres. This results in a product that has a better or equal performance to carpets using round fibres.

Embodiments of the present invention exhibit a higher needling efficiency, meaning higher web modulus at equal needling parameters compared to a round cross section based needlefelt of the same base weight. Hence for a certain desired modulus, a lower stitch density or stitch depth can be applied. This results in a higher production speed in cases where the needling is the speed limiting factor.

A process for making a carpet according to embodiments of the present invention is based on the use of solid multilobal fibres typically received as bales that undergo a preliminary treatment in a “bale-breaker” for homogenising the batch by grading it according to the colour and to the fiber type (denier, length, crimp, composition). The multilobal fibres can be made from polypropylene fibres or polyester (PET) fibres. The multilobal fibres are preferably trilobal fibres. A first rough opening of the fiber staples, compacted by the being inside the bales, is implemented in a carding willow.

The fibers are repeatedly aired inside a storage chamber. Homogenised fibres are sent to a carding machine comprising: a feeder for receiving the fibres and laying it homogeneously, in the shape of a mat on a conveyor. The carding machine is formed by a series of toothed cylinders of various diameters providing the fibre paralleling and the laying of the same onto a conveyor as a light and homogeneous card web. The fibrous web may be conveyed to a crosslapping machine so as to crosslap the card web into a batt of material. The number of layers or laps which constitute the batt determines the desired weight of the non-woven layer. A lap roller receives the card web and lays it as a multilayer onto a conveyor that feeds a needlepunching apparatus. Needlepunching is carried out by means of the action of a plurality of needles, moving orthogonally to the fibre mat feed in a reciprocating motion, that seize the fibres and drag them through the fibre mass, binding and compacting. Finally a binder is applied, e.g. a latex, a binding power or binding fibres are activated by heat. Alternatively one or more backing layers can be applied on the underside.

Embodiments of the present invention exhibit a better crosslapper behaviour, and a lower crosslapping width needed for a certain end width of the carpet. The crosslapper travelling distance is higher with round fibre compared to trilobal or multilobal fibre. With round fibre the difference between travelling distance and the final carpet width is typically >20%, with the trilobal fibre it is possible go below 20%. This confirms the increased anchoring of the trilobal or multilobal fibres.

Accordingly, an advantage of embodiments of the present invention can be better crosslapper behaviour, e.g. a lower crosslapping width needed for a certain end width of the carpet.

Several stretching steps between the crosslapper and the winding induce a width reduction. For a 4.30 m wide final nonwoven the crosslapper ran for the 300 g/m² round fibre based reference at a width of 5.60 m. The multilobal e.g. trilobal nonwoven crosslapper travelling distance at 5.60 m made a nonwovens which was wider than 4.30 m. Reducing the travelling distance to 5 meters (20% greater than the final non-woven width) resulted in a satisfactory width. Thus the travelling distance can be less than 20% bigger than the final non-oven width. An advantage of this effect is that in cases where the crosslapper is running at maximum speed (limited by inertia forces) with round fibres, running with multilobal such as trilobal fibres at the same speed settings can mean that downstream of the crosslapper a higher machine speed is possible, meaning more square meters per time unit of the nonwoven. Contrary to the perceived disadvantages of processing multilobal fibres such as trilobal fibres, this indicates a process advantage.

Comparative Tests

In various embodiments non-wovens were manufactured using round and solid trilobal fibres. Nonwoven carpets with both solid trilobal and solid round fibres were produced with identical settings.

### First Embodiment

Non-wovens were manufactured with polypropylene 4.4 dtex trilobal fibres and 6.7 dtex round fibres. These two fibres have the same coverage distance as observed under the microscope. For the 4.4 tdtex trilobal fibre the covering distance corresponds (the distance across a fibre of solid material) closely with 6.7 dtex linear mass density round cross-section fibre.

With each fibre, a 5 layer nonwoven was constructed using the following parameters:
First needle board: top down 75 stitches/cm², 11.5 mm penetration depth, 4500 needles/meter at entry, 7000 needles/m at exit, needle type 15×18×36 3,5 R222 G3037.
Second needle board: bottom up 100 stitches/cm², 11mm penetration depth, 7000 needles/m for the whole board, needle type 15×18×36 3,5 R222 G3037.
Third needle board: top down 100 stitches/cm², 8 mm penetration depth, 7000 needles/m for the whole board, needle type 15×18×36 3,5 R222 G3037.
With the round fibre base weights of the non-woven produced were 300 and 350 grams/sq m.
With the trilobal fibre base weights: 190, 210, 225, 240, 260, 280 g/m², were manufactured to match qualities of non-woven manufactured with round fibres.

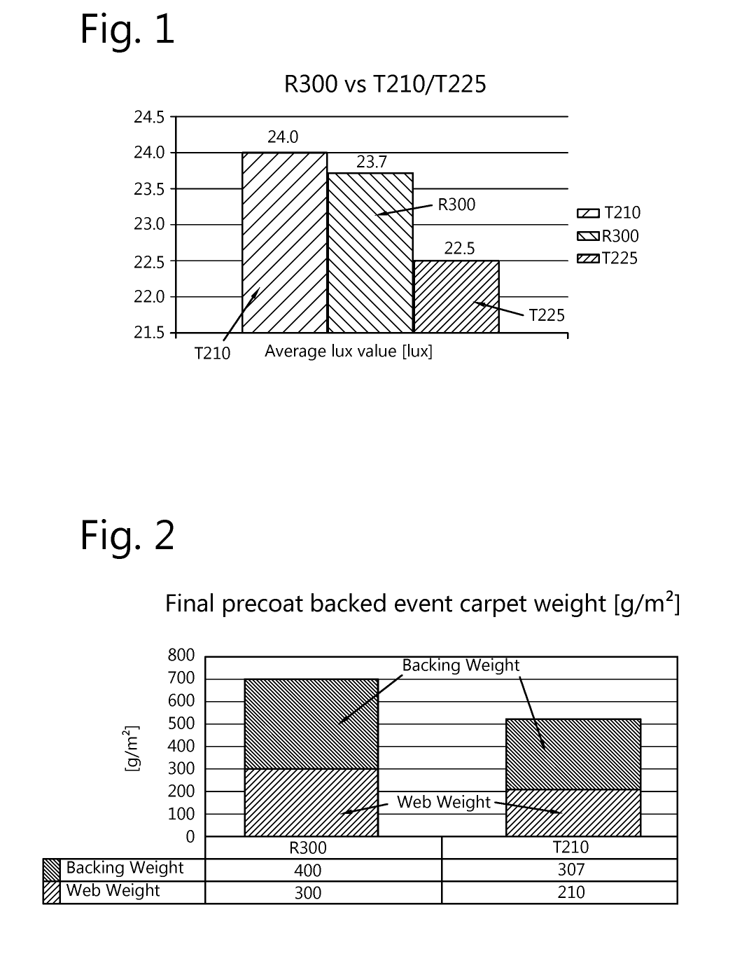

This embodiment of the present invention exhibits a higher coverage to weight ratio (FIG. 1). To measure coverage a sample is placed on a box with a glass plate on top. A light flux sensor (lux meter) is placed in the box. The sample is placed on top of the glass plate and the light that is transmitted through the sample is detected by the sensor. A white nonwoven layer with round fibres was used as a reference sample with a base weight of 300 g/m². An embodiment of the present invention with trilobal fibre, 210 g/m² and an average modification ratio of 2 has the same light transmission value as the reference sample with round fibre. Therefore, the 210 g/m² trilobal fibre based nonwoven is equal in coverage compared with the round reference even though the density of the trilobal non-woven was less.

Accordingly, a technical advantage of carpets in accordance with embodiments of the present invention can be the coverage (ability to prevent see-through) and the covering distance is better for a multilobal such as trilobal carpet. The trilobal fibres are preferably made from polypropelene or polyester (PET). An advantage of embodiments of the present invention can be a higher coverage to weight ratio for multilobal fibres such as trilobal fibres compared to round staple fibres, resulting in a weight saving of at least 20% compared to round fibres of the same dtex or the same coverage, preferably up to 25%, more preferably up to 30% at the nonwoven or carpet level.

An advantage of embodiments of the present invention can be lower absorption of precoat backing material leading to lower overall carpet weight, e.g. for flat automotive carpet with the same needling settings as the current round fibre carpet. This effect can lead to significant lower weight of the end product.

An advantage of embodiments of the present invention can be a lower end weight for other backing methods.

For example, this embodiment of the present invention exhibits a lower absorption of precoat backing material leading to lower overall carpet weight (see FIG. 2). This is valid for flat automotive carpet with multilobal fibres such as trilobal fibres with the same needling settings as the current round carpet. This effect leads to significant lower weight of the end product.

This embodiment of the present invention exhibits lower weight of the final product for other backing methods (see FIG. 3).

This embodiment of the present invention exhibits a higher homogeneity of carpet meaning lower weight variation in machine and cross-machine direction (Table. 1) at a lower g/m² fibre weight.

Hence, an advantage of embodiments of the present invention can be a higher homogeneity of carpet meaning lower weight variation in machine and cross-machine direction at a lower g/m² fibre weight.

TABLE 1

| | Average weight | Standard |
|---|---|---|
| | [g/m²] | deviation |
| 300 g/m² Round fibers | 292.58 | 18.35 |
| 350 g/m² Round fibers | 343.94 | 19.5 |
| 200 g/m² Trilobal fibers | 204.93 | 13 |
| 225 g/m² Trilobal fibers | 228.33 | 12.22 |
| 250 g/m² Trilobal fibers | 246.65 | 12.89 |

Accordingly, a technical advantage of carpets in accordance with embodiments of the present invention can be the mass homogeneity of nonwoven facing layer with solid multilobal such as solid trilobal fibres despite the use of a lower g/m² fibre weight. Also the web is closer and has a more even surface.

This embodiment of the present invention exhibits a lower carbon footprint compared to current versions. The material impact is directly proportional to weight savings realized. Impact on the supply chain is directly proportional to weight savings realized.

These results were obtained with identical needling settings as currently used during automotive carpet production.

### Second Embodiment

In further embodiments samples manufactured as defined in embodiment 1 were bound using three different backing methods:
1. Precoat backing
2. Full bath resin backing

### Precoat Backing Embodiment

A suspension of latex and chalk in water is applied on the most hairy side of a round needlefelt polypropylene fibres with a weight of 300 g/m² and polypropylene trilobal needlefelt having weights of 260 g/m² and 210 g/m² via a kiss roll system. The set point for the density of the suspension is 1200 g/liter. The carpet then went through a first oven at 140° C. and secondly through an oven at 120° C. Afterwards the edges of the carpet are cut off and the remaining 4 meters wide carpet is cut into two parts of around 2 meters in width.

The following carpets were backed and final roll weights were observed (Table 2 carried out on 4 m wide carpet):

TABLE 2

| | | | | | | Backing | |
|---|---|---|---|---|---|---|---|
| | | | Carpet | | Backing | and foil | |
| | | Roll | weight | Fibre | and foil | weight | Backing |
| | # linear | weight | per m² | weight | weight | per m² | weight |
| Web weight [g/m²] | meters | [kg] | [g/m²] | [kg] | [kg] | [g/m²] | [g/m²] |
| Round 300 g/m² | 33.5 | 97.0 | 716.7 | 40.6 | 56.4 | 416.7 | 386.7 |
| Trilobal 260 g/m² | 37.0 | 85.0 | 568.6 | 38.9 | 46.1 | 308.6 | 278.6 |
| Trilobal 210 g/m² | 57.3 | 122.5 | 529.2 | 60.2 | 62.3 | 269.2 | 239.2 |

The trilobal carpets take up less of the chalk-latex suspension than the round fibre one. The 210 g/m² does even take up less than 260 g/m² because the 210 g/m² web was made with the same needling parameters as the 260, so it can be expected that it is a more intense needled structure, and therefore more closed. The latex has not penetrated so deep into the carpet. This has the advantage that chances of strike through of the backing are lower.

Taber tests were executed at 50 cycles, 100 cycles, 150 cycles and 200 cycles to compare the performance. There were no big differences in pilling observable, however at 50 cycles and 100 cycles the polypropylene trilobal fibre based carpet performed slightly better.

The trilobal carpet was more homogeneous and lustrous than round fibre carpet.

### Embodiments with a Full Bath Latex Backing

A wet latex weight of 245 g/m² was applied on the carpet samples using the same setup as for the precoat backing. A foulard was used to press the latex through the nonwoven to insure full impregnation. The carpet width after trimming the edges was exactly 4 meter.

The following carpets were backed and final roll weights were observed (Table 3):

TABLE 3

| | | | | | | Backing | |
|---|---|---|---|---|---|---|---|
| | | | Carpet | | Backing | and foil | |
| | | Roll | weight | Fibre | and foil | weight | Backing |
| | # linear | weight | per m² | weight | weight | per m² | weight |
| Web weight [g/m²] | meters | [kg] | [g/m²] | [kg] | [kg] | [g/m²] | [g/m²] |
| Round 300 g/m² | 35.50 | 52.00 | 366.20 | 42.60 | 9.40 | 66.20 | 36.20 |
| Trilobal 260 g/m² | 67.45 | 96.50 | 357.67 | 70.15 | 26.35 | 97.67 | 67.67 |
| Trilobal 210 g/m² | 70.00 | 82.00 | 292.86 | 58.80 | 23.20 | 82.86 | 52.86 |

The automotive carpet with polypropylene trilobal fibres showed a stiffness and coverage especially of the Trilobal 210 g/m² based automotive carpet which was sufficient. Also the trilobal carpet had a pure white colour with a richness of the carpet.

Mechanical Results

The round cross-section fibre reference carpets and their trilobal equivalent are compared for the following properties (FIGS. 4-8).

FIG. 4 shows a comparative example for modulus of a reference carpet (R300) and a precoat embodiment of the present invention (T210) showing the improvement in a higher modulus.

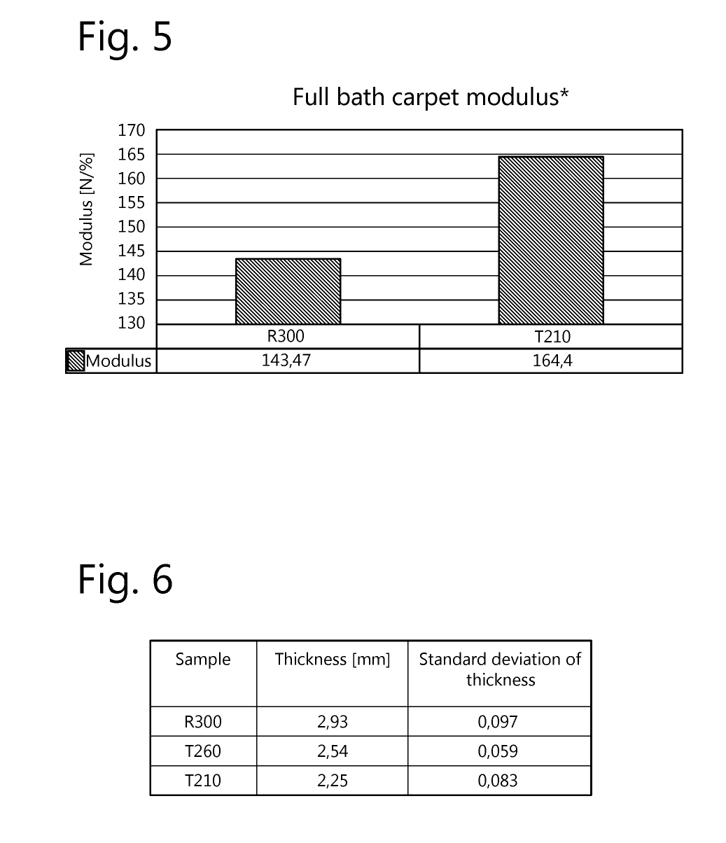

FIG. 5 shows a comparative example for modulus of a reference carpet (R300) and a full bath embodiment of the present invention (T210) showing the improvement in a higher modulus.

For every backing method, the modulus, which is an important mechanical parameter for automotive carpet as it is directly correlated with wear behaviour, is higher for trilobal fibre. Hence, another advantage of embodiments of the present invention is that a higher modulus can be achieved compared to round when using multilobal such as trilobal fibre when used with the same stitch density, needling efficiency effect. A higher fibre-fibre friction can also be achieved.

Automotive carpets according to embodiments achieve a modulus of the facing layer higher than 150 N/%.

FIG. 6 shows a comparative example for thickness and variation of thickness of a reference carpet (R300) and embodiments of the present invention (T260, T210) showing the improvement in uniformity.

The higher needling efficiency leads to lower thickness of the trilobal fibre based nonwovens and a more closed structure. This was measured on the full bath backed automotive carpet.

With reference to FIG. 8a a trilobal fibre having a trilobal cross-sectional geometry including three lobes defined by three tips, a generally solid central core section running axially through the fibre and outer sides of the fibre defining a smoothly curved contour extending between each tip and a neighbouring tip, each side including a concave region located at an approximate midpoint between neighbouring tips. However triangular and even convex curves can be useful for certain applications.

FIG. 8b shows a cross-section through a non-woven made according to an embodiment of the present invention. Polypropylene fibres can be seen running across the page, running towards the viewer (and hence at a right angle to the fibres across the page and hence a result of the carding operations) and running down the page (resulting from needling).

FIG. 8c shows a top view of the same non-woven as in FIG. 8b. Fibres can be seen running in all directions as well as needled fibres descending into the body of the non-woven. It demonstrates the light blocking fibre tangle produced by embodiments of the present invention.

The lobe tip of one fibre touches another fibre which spaces the fibres while using a low weight per meter fibre and this provides a needle punched carpet of good mechanical properties with excellent coverage but low weight. The fibre structure in accordance with embodiments of the present invention is more impermeable to light along a line through the nonwoven compared with nonwovens made of fibres with a round cross-section. This results in a better than expected coverage with the nonwoven structures in accordance with embodiments of the present invention when compared weight for weight with non-wovens made with round fibres.

Further Comparative Tests

Tests have been performed with polypropylene non-wovens made with black solid round 5.5 dtex (black) and white 5.8 dtex solid trilobal. For the same base weights, the coefficient of variation (CV) is 6.1 for trilobal and 6.3 for round. There is a better mass homogeneity for trilobal compared to round. As thin spots are avoided with better mass homogeneity, this effect is synergetic with the higher coverage to weight ratio.

Shrinkage tests were performed with polypropylene non-wovens made with 5,5 dtex trilobal fibres at 180 g/m², 5,5 dtex round cross-section at 205 g/m² and 8,9 dtex round cross-section 235 g/m². The preparation of the samples was as follows:

Conditioning at 20° C. and 65% humidity

2 hours in an oven at 60° C.+cooldown

2 hours in water at 20° C.

24 h in the oven at 60° C., and

Conditioning at 20° C. and 65% humidity.

Shrinkage along the machine direction and the transverse directions was measured. All samples met a requirement of less than 1.2% shrinkage. The ratio between the maximum and minimum shrinkage among the samples tested was as follows:

5.5 dtex trilobal fibres at 180 g/m² —machine: 1.1, transverse: 1.13 5.5 dtex round cross-section at 205 g/m² —machine: 1.5, transverse: 1.17 8.9 dtex round cross-section at 235 g/m² —machine: 1.06, transverse: 1.04.

These results indicate that the uniformity of the trilobal product resulted in less variation between samples compared with nonwovens made with round cross-section fibres of the same dtex but higher g/m². The trilobal product made from fibres of 5.5 dtex was similar to nonwoven made with round cross-section fibres of a higher dtex and weight.

1-35. (canceled)

36. An automotive carpet comprising:
at least a needle punched facing layer as a top layer made of staple fibers, wherein the staple fibers comprise at least 50% by weight of solid multilobal fibers, and at least a partial binding of the fibers of the needle punched facing layer.

37. The automotive carpet according to claim 36, whereby the solid multilobal fiber content is at least 60%, 70, 80 or 90% by weight of a total fiber content.

38. The automotive carpet according to claim 36, whereby an outer cross-section of the multilobal solid fibers is substantially trilobal.

39. The automotive carpet according to claim 36, wherein a modulus of the facing layer is higher than 150 N/wt %.

40. The automotive carpet according to claim 36, wherein the multilobal fibers have an average modification ratio of 1.5 to 6.

41. The automotive carpet according to claim 36, wherein the multilobal fibres have a ratio of a circumscribing outer radius (Rₒ) to a tip diameter (Dₜ) of between 2.0 and 10.0.

42. The automotive carpet according to claim 36, wherein the at least partial binding comprises a latex compound, a binder fiber, a binder powder or a binder layer.

43. The automotive carpet according to claim 36, wherein the facing layer has a weight of 100 and 300 grams per square meter.

44. The automotive carpet according to claim 36, wherein a linear mass density of the solid multilobal fibers is between 3.3 until 17 dtex,

45. The automotive carpet according to claim 36, wherein the solid multilobal fibers have a mixture of fiber linear mass densities.

46. The automotive carpet according to claim 36, wherein the carpet is velour carpet and the solid multilobal fibers are up to 17 dtex.

47. The automotive carpet according to claim 36, wherein the multilobal fibre has a lobed cross-sectional geometry including a discrete number of lobes each having a tip, and a solid central core section running axially through the fiber, each outer side of the fiber defining a curved contour extending between each tip and a neighboring tip.

48. The automotive carpet according to claim 47, wherein each side of the multilobal fiber includes a concave region located at an approximate midpoint between neighboring tips.

49. The automotive carpet according to claim 36, wherein the multilobal fiber has a lobed cross-sectional geometry including a discrete number of lobes each having a tip, and a solid central core section running axially through the fiber, each outer side of the fiber defining a contour extending between each tip and a neighboring tip, each such contour comprising any one of: a straight line, a concave shape or a convex shape.

50. The automotive carpet according to claim 49, wherein, in the case of the convex shape, the convex shape does not extend out from the core such as to extend beyond a line drawn between two adjacent tips.

51. The automotive carpet according to claim 36, wherein the core of the fiber does not include an axial hole or void.

52. A process for making an automotive carpet having at least a needle punched facing layer as a top layer made of staple fibers, wherein the staple fibers comprise at least 50% by weight of solid multilobal fibers, the process comprising:
conveying a fibrous card web to a crosslapping machine and crosslapping the card web into a batt of material, wherein a multilobal nonwoven crosslapper travelling distance is less than 20% and greater than 10% of a final width of the needle punched facing layer.

53. The process according to claim 52, wherein the multilobal fibers have an average modification ratio of 1.5 to 6.

54. The process according to claim 52, wherein the multilobal fibers have a ratio of a circumscribing outer radius (Rₒ) to a tip diameter (Dₜ) of between 2.0 and 10.0.

55. The process according to claim 52, further comprising the step of installing the carpet in an automotive vehicle.
